(19) United States
(12) Patent Application Publication
(10) Pub. No.: US 2012/0245043 A1
(43) Pub. Date: Sep. 27, 2012

(54) SYSTEMS AND METHODS FOR DETECTING AND IDENTIFYING CONTAMINANTS IN A GASEOUS ENVIRONMENT

(75) Inventor: William G. England, Suwanee, GA (US)

(73) Assignee: Purafil, Inc., Doraville, GA (US)

(21) Appl. No.: 13/426,254

(22) Filed: Mar. 21, 2012

Related U.S. Application Data
(60) Provisional application No. 61/454,665, filed on Mar. 21, 2011.

(51) Int. Cl. C40B 30/00; B82Y 15/00

(52) U.S. Cl. 506/7; 977/700; 977/742; 977/773; 977/902

(57) ABSTRACT

A method for identifying a contaminant in an environment includes providing a sensor array, the sensor array including a plurality of sensing platforms, each of the sensing platforms including a corrodible metal. A reaction is detected on the corrodible metal on one or more of the sensing platforms to identify a reaction pattern, and the reaction pattern is compared to known reaction characteristics of the corrodible metals. Based on this comparison, the contaminant, such as a corrosive gas, can be identified. The sensing platform may include a quartz crystal microbalance or a nanostructure. In some features, at least one of the corrodible metals includes gold, and a detected reaction of the gold corrodible metal indicates the presence of adverse temperature or humidity conditions in the environment.

### RELATED APPLICATION

This application claims the benefit of U.S. Provisional Patent Application No. 61/454,665, filed Mar. 21, 2011, the entire contents of which are incorporated by this reference in its entirety.

### FIELD OF THE INVENTION

The present application relates generally to methods for detecting and identifying contaminants in a gaseous environment, and in particular to detecting and identifying undesirable temperature, humidity and corrosive gas conditions in, for example, a microelectronics manufacturing environment.

### BACKGROUND

Many metal-containing devices and structures must function in corrosive atmospheres which cause them to deteriorate over time. Corrosion may take the form of metal oxides resulting from reaction with oxygen in the air, or may by compounds formed with the effluent of industrial processes, such as hydrogen sulfide.

In the electronics industry, for example, a substantial amount of warranty repair work is attributable to corrosion. Accordingly, the ability to accurately monitor corrosion and take appropriate measures to deter its spread are of utmost importance to the industry.

Historical methods for of monitoring corrosion have included using a reactivity monitoring procedure such as the so-called “coupon” method. Under this method, strips of copper are placed in the environment where corrosion is to be monitored. The coupons carry an initial copper oxide corrosion thickness of about 100 Angstroms. After a period of time in the environment, usually around thirty days, the change in thickness of corrosive buildup on the strips, or coupons, is measured using a complex coulometric reduction procedure, well known to those skilled in the art.

One major disadvantage of the coupon method of reactivity monitoring, however, is the destructive nature of the measurement. Once the thickness of corrosion on the coupon has been measured, the coupon must be discarded and, although the measurement may be projected over a desired period of time, further actual corrosion measurements may only be taken with a new coupon.

More recently, reusable sensing platforms have been used. In one example, disclosed in U.S. Pat. No. 5,208,162 to Michael W. Osborne et al., a metal such as copper, silver or nickel is coated onto a quartz crystal microbalance (“QCM”). The QCM has a measurable characteristic vibration frequency that changes as the metal coating on the QCM corrodes in the presence of a corrosive atmosphere, thus signaling the presence of the contaminant in the atmosphere.

Metal-coated nanostructures may also be used as the sensing platform, such as those described in Patent Cooperation Treaty application PCT/US2005/032510 to Purafil, Inc. As described therein, at least one nanostructure includes at least one reactive material such as copper or silver. When exposed to a corrosive atmosphere, the reactive material reacts with the atmosphere to cause a change in the characteristics of the reactive material that may be detected by the nanostructure. The nanostructure may include a microcantilever, a nanotube, a carbon nanotube, a nanoparticle, a nanoball, or a nanocantilever.

While the systems and methods described in the documents described above may be useful in determining whether a contaminant is present in a gaseous atmosphere, they do not identify the nature of the contaminant, such as adverse temperature or humidity conditions or the presence of a specific contaminant such as hydrogen fluoride gas. Identification of the nature of the contaminant may provide a more specific indication of the source of the contaminant. For example, the presence of a hydrogen fluoride contaminant could indicate a failure of a system component that uses this gas or a spill of a cleaning product that includes this gas.

Systems and methods for identifying the nature of the contaminant would thus be desirable.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Features of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

One feature of the invention includes a method for identifying a contaminant in an environment by providing a sensor array, the sensor array including a plurality of sensing platforms, each of the sensing platforms including a corrodible metal. A reaction is detected on the corrodible metal on one or more of the sensing platforms to identify a reaction pattern, and the reaction pattern is compared to known reaction characteristics of the corrodible metals. Based on this comparison, the contaminant can be identified.

In other features, the sensing platform is a quartz crystal microbalance or a nanostructure. In yet other features, the nanostructure is a microcantilever, a nanotube, a carbon nanotube, a nanoparticle, a nanoball, a nanocantilever or combinations thereof.

In certain features, the corrodible metal is copper, silver, cobalt, permalloy, aluminum, gold, zinc, platinum, molybdenum, titanium, tungsten, nickel, alloys of these metals, and combinations thereof.

In yet other features, the sensor array includes at least 6 sensing platforms. In further features, the sensor array includes at least 3 sensing platforms, at least 4 sensing platforms, at least 5 sensing platforms, from 3 to 12 sensing platforms, from 4 to 9 sensing platforms or from 5 to 8 sensing platforms.

In some features, at least one of the corrodible metals includes gold, and a detected reaction of the gold corrodible metal indicates the presence of adverse temperature or humidity conditions in the environment.

In other features, the contaminant includes a corrosive gas, adverse temperature conditions, adverse humidity conditions, or combinations thereof.

### BRIEF DESCRIPTION OF THE DRAWINGS

Illustrative features of the present invention are described in detail below with reference to the following drawing figures:

FIG. 1 is a top perspective view of a sensor array according to a feature of the invention.

FIG. 2 is a side view of a sensing platform according to a feature of the invention.

FIG. 3 is a top perspective view of the sensing platform of FIG. 2.

FIG. 4 is a diagram of a corrosion monitor according to a feature of the invention.

FIG. 5 is a top view of a nanostructure according to a feature of the invention.

### DETAILED DESCRIPTION

The subject matter of features of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

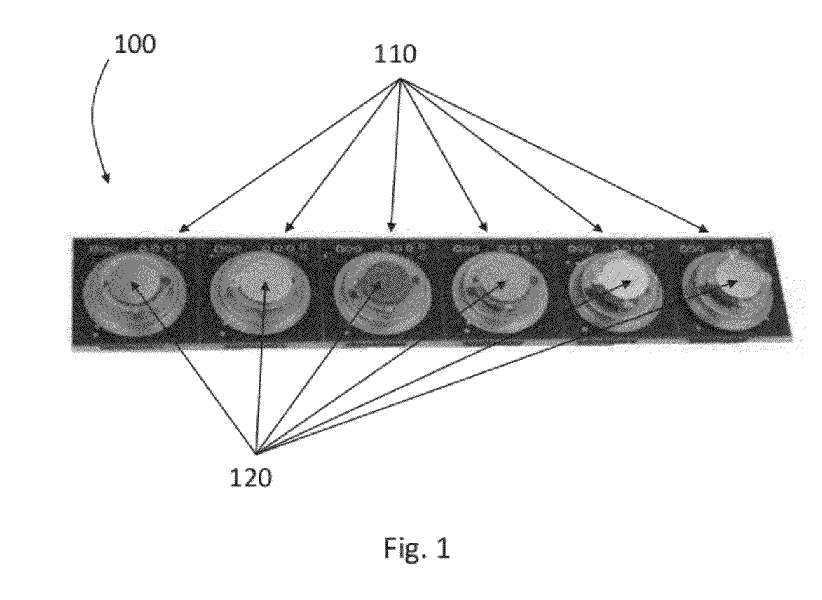

With reference to FIG. 1, particular features of the invention include a sensor array 100 for monitoring contaminants in a gaseous environment. The sensor array 100 includes a plurality of sensing elements 110. Each sensing element 110 includes a metal-coated sensing platform 120.

In some features of the invention, each sensing platform 120 may include a quartz crystal microbalance (“QCM”). Systems and methods for forming and operating metal-coated QCMs are described in U.S. Pat. No. 5,208,162 to Osborne et al. (“Osborne”), the entire disclosure of which is incorporated in its entirety by this reference.

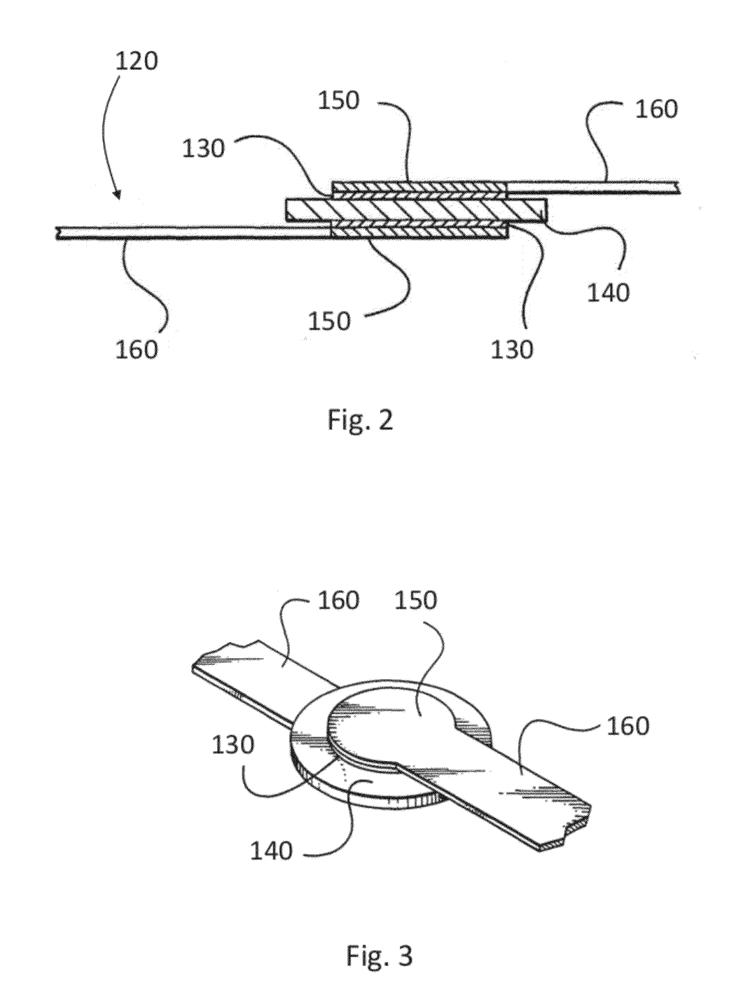

FIGS. 2 and 3 illustrate an exemplary, but by no means limiting, sensing platform 120. An approximately 30 angstrom thick layer of a bonding agent 130 such as chromium is bonded or deposited onto both the top and bottom surfaces of a QCM 140, and a layer of a corrodible metal 150 is then bonded or deposited onto each of the layers of the bonding agent 130. The bonding agent 130 serves to bond the corrodible metal 150 to the QCM 140. An oscillator (not shown) as described in Osborne, is attached to the layers of corrodible metal 150 by leads 160. The construction, mounting, cleaning and driving of the QCM 140 utilize techniques well known in the QCM art.

Each QCM 140 has a measurable characteristic vibration frequency that changes as the corrodible metal 150 on the QCM 140 corrodes in the presence of a corrosive atmosphere, thus signaling the presence of the contaminant in the atmosphere. An exemplary atmosphere is a microelectronic manufacturing environment.

Each QCM 140 in the sensor array 100 may be coated with a corrodible metal 150. Exemplary metals include, but are not limited to, copper, silver, cobalt, permalloy, aluminum, gold, zinc, platinum, molybdenum, titanium, tungsten, nickel, alloys of these metals, and combinations thereof. Each of the corrodible metals 150 have specific corrosion characteristics that allow corrosion patterns to be identified. Specifically, mass changes in the corrodible metals 150 induced by environmental conditions such as temperature, humidity and the presence of a corrosive gas can be precisely and accurately recorded. For example, microelectronics manufacturers can monitor process environments and relate this information to the production quality or process yields.

In one feature, the sensor array 100 includes QCMs 140 coated with corrodible metals 150 including gold, aluminum, permalloy, cobalt, silver and copper.

In other features, the sensor array 100 may include at least 3 QCMs 140, each coated with a different corrodible metal 150.

In a further feature, the sensor array 100 can include at least 4 QCMs 140, each coated with a corrodible metal 150.

In yet another feature, the sensor array 100 can include at least 5 QCMs 140, each coated with a corrodible metal 150.

In yet further features, the sensor array 100 can include at least 6 QCMs 140, each coated with a corrodible metal 150.

In other features, the sensor array 100 can include from 3-12 QCMs 140, each coated with a corrodible metal 150, or from 4-9 QCMs 140 coated with a corrodible metal 150, or from 5-8 QCMs 140 coated with a corrodible metal 150.

In further features, the sensor array 100 can include more than 6 QCMs 140, each coated with a corrodible metal 150.

In any of the features described above, the corrodible metal 150 on each QCM 140 may be a different metal. Alternatively, 2 or more of the QCMs 140 may have the same metal coated thereon.

The use of multiple QCMs 140 coated with varying corrodible metals 150 allows for identification of particular corrosive gases. If it were known, for example, that hydrogen fluoride gas causes corrosion on QCMs coated with metals A, B and C, but not those coated with metals X, Y or Z, then a pattern recognition process could be used to identify the presence of hydrogen fluoride gas if such a corrosion pattern is detected. The identification of a particular corrosive gas in a system can be used to help identify the failure of a particular piece of equipment known to contain that gas. Early detection of the failure of the equipment and the presence of the corrosive gas in turn minimizes system down time and product failures.

In certain features of the invention, adverse temperature and humidity conditions can be detected by observing a reaction of a QCM coated with gold. Gold does not react or corrode in the presence of the gases most commonly used in microelectronics manufacturing operations, so if a reaction is noted on the gold-coated QCM it can be inferred that another contaminant, such as adverse temperature or humidity conditions, is present in the environment. The gold-coated QCM thus acts as a reference sensor in the sensor array.

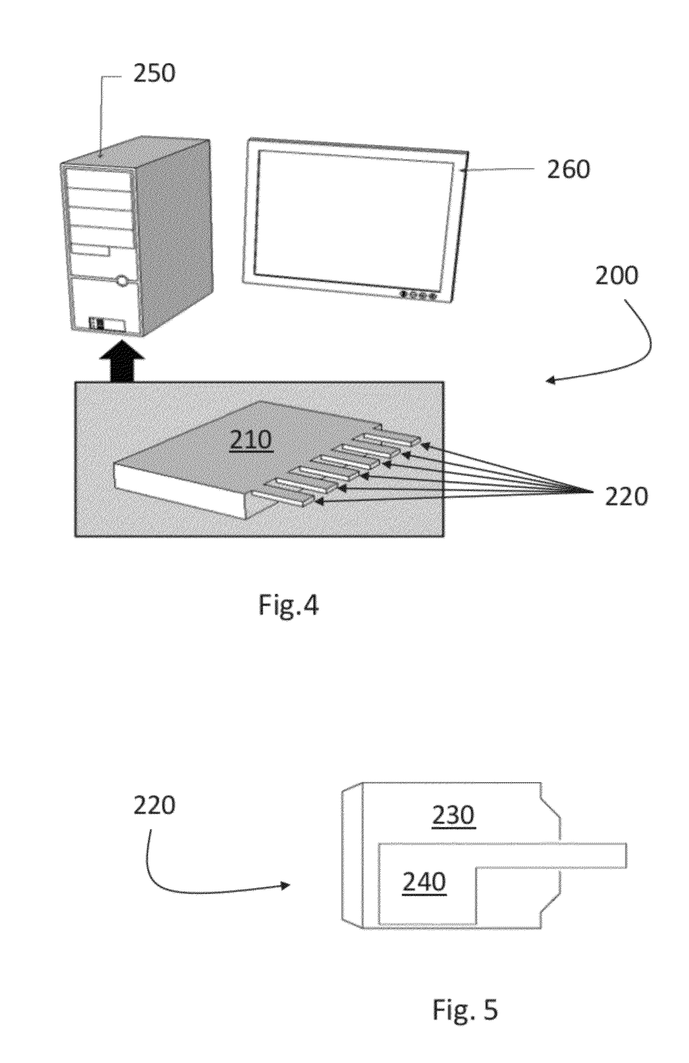

With reference to FIGS. 4 and 5, other features of the invention include a corrosion monitor 200 for monitoring contaminants in a gaseous environment. The corrosion monitor includes a sensor array 210 having a plurality of nanostructures 220 such as microcantilevers. Each nanostructure 220 includes a substrate such as a silicon wafer 230 and a corrodible metal 240. Systems and methods for forming and operating such nanostructures are described in Patent Cooperation Treaty application PCT/US2005/032510 to Purafil, Inc., the entire disclosure of which is incorporated in its entirety by this reference.

The nanostructure is in the form of, but is not limited to, a microcantilever, a nanotube, a carbon nanotube, a nanoparticle, a nanoball, a nanocantilever, or any combination thereof. A suitable corrodible metal 240 can include, but is not limited to, copper, silver, cobalt, permalloy, aluminum, gold, zinc, platinum, molybdenum, titanium, tungsten, nickel, alloys of these metals, and combinations thereof.

Furthermore, the apparatus shown in FIG. 4 may include a means for detecting a reaction associated with the corrodible metal 240. A means for detecting a reaction associated with the corrodible material 240 can be, for example, facilitated by a processor 250 in operative communication with the sensor array 210 as shown. Output from the processor 250 may be displayed on a monitor 260.

A reaction associated with the corrodible metal 240 can include, but is not limited to, a change in mass, displacement, vibration frequency, electrical resistance, electrical voltage, a physical characteristic of the reactive material, an electrical characteristic of the reactive material, a chemical characteristic of the reactive material, or any combination thereof.

In one feature, the sensor array 210 includes nanostructures 220 having corrodible metals 240 including gold, aluminum, permalloy, cobalt, silver and copper.

In other features, the sensor array 210 may include at least 3 nanostructures 230, each coated with a corrodible metal 240.

In a further feature, the sensor array 210 can include at least 4 nanostructures 230, each coated with a corrodible metal 240.

In yet another feature, the sensor array 210 can include at least 5 nanostructures 230, each coated with a corrodible metal 240.

In yet further features, the sensor array 210 can include at least 6 nanostructures 230, each coated with a corrodible metal 240.

In other features, the sensor array 210 can include from 3-12 nanostructures 230, each coated with a corrodible metal 240, or from 4-9 nanostructures 230 coated with a corrodible metal 240, or from 5-8 nanostructures 230 coated with a corrodible metal 140.

In further features, the sensor array 210 can include more than 6 nanostructures 230, each coated with a corrodible metal 240.

In any of the features described above, the corrodible metal 240 on each nanostructure 230 may be a different metal. Alternatively, 2 or more of the nanostructures 230 may have the same metal coated thereon.

The use of multiple nanostructures 230 coated with varying corrodible metals 240 allows for identification of particular corrosive gases. If it were known, for example, that hydrogen fluoride gas causes corrosion on nanostructures including metals A, B and C, but not those that include metals X, Y or Z, then a pattern recognition process could be used to identify the presence of hydrogen fluoride gas if such a corrosion pattern is detected. The identification of a particular corrosive gas in a system can be used to help identify the failure of a particular piece of equipment known to contain that gas. Early detection of the failure of the equipment and the presence of the corrosive gas in turn minimizes system down time and product failures.

In certain features of the invention, adverse temperature and humidity conditions can be detected by observing a reaction of nanostructure including gold as the corrodible metal. Gold does not react or corrode in the presence of the gases most commonly used in microelectronics manufacturing operations, so if a reaction is noted on the gold-containing nanostructure it can be inferred that another contaminant, such as adverse temperature or humidity conditions, is present in the environment. The gold-containing nanostructure thus acts as a reference sensor in the sensor array.

While the features described above include the use of metal-coated QCMs and metal-containing nanostructures, the sensing platform is not so limited. Any suitable sensing platform that allows for detection of a reaction with the metal on the sensing platform (such as corrosion of the metal due to the presence of a corrosive gas) may be utilized.

Pattern recognition techniques generally described above are explained in more detail in the following non-limiting examples:

### Example 1

A sensor array having 6 sensing platforms, each with a different corrodible metal, were provided. The corrodible metals provided on the sensing platforms were gold, aluminum, permalloy, cobalt, silver and copper.

When the sensor array was placed in an unknown contaminated environment, corrosion of the cobalt metal was detected, while none of the other metals exhibited a substantial reaction. Based on this observation, it was determined that the sensor array was exposed to hydrogen fluoride gas, as this gas reacts substantially with cobalt but not the other corrodible metals.

### Example 2

A sensor array having 6 sensing platforms, each with a different corrodible metal, were provided. The corrodible metals provided on the sensing platforms were gold, aluminum, permalloy, cobalt, silver and copper.

When the sensor array was placed in an unknown contaminated environment, corrosion of the all metals, including gold, was detected. Based on this observation, it was determined that the sensor array was exposed to elevated temperature or humidity conditions, because gold was known not to react with any of the gases used in the manufacturing system.

### Example 3

A sensor array having 6 sensing platforms, each with a different corrodible metal, were provided. The corrodible metals provided on the sensing platforms were gold, aluminum, permalloy, cobalt, silver and copper.

When the sensor array was placed in an unknown contaminated environment, corrosion of the silver metal was detected, while the copper and gold metals did not exhibit a substantial reaction. Based on this observation, it was determined that the sensor array was exposed to sulfur dioxide gas, as this gas reacts substantially with silver but not copper or gold.

### Example 4

A sensor array having 6 sensing platforms, each with a different corrodible metal, were provided. The corrodible metals provided on the sensing platforms were gold, aluminum, permalloy, cobalt, silver and copper.

When the sensor array was placed in an unknown contaminated environment, corrosion of the copper metal was detected, while the silver and gold metals did not exhibit a substantial reaction. Based on this observation, it was determined that the sensor array was exposed to hydrogen sulfide gas, as this gas reacts substantially with copper but not silver or gold.

### Example 5

### Prophetic

A sensor array having 6 sensing platforms, each with a different corrodible metal, is provided. The corrodible metals provided on the sensing platforms are gold, aluminum, permalloy, cobalt, silver and copper.

When the sensor array is placed in an unknown contaminated environment, corrosion of the aluminum metal is detected, while the other metals do not exhibit a substantial reaction. Based on this observation, it is determined that the sensor array was exposed to a chloride gas, as this gas reacts substantially with aluminum but not the other metals in the sensor array.

Different arrangements of the components depicted in the drawings or described above, as well as components and steps not shown or described are possible. Similarly, some features and subcombinations are useful and may be employed without reference to other features and subcombinations. Features of the invention have been described for illustrative and not restrictive purposes, and alternative features will become apparent to readers of this patent. Accordingly, the present invention is not limited to the features described above or depicted in the drawings, and various features and modifications can be made without departing from the scope of the claims below.

That which is claimed is:

1. A method for identifying a contaminant in an environment, comprising:
providing a sensor array, the sensor array comprising a plurality of sensing platforms, each of the sensing platforms comprising a corrodible metal;
detecting a reaction on the corrodible metal on one or more of the sensing platforms to identify a reaction pattern;
comparing the reaction pattern to known reaction characteristics of the corrodible metals; and
identifying the contaminant based on the comparison.

2. The method of claim 1, wherein the sensing platform is a quartz crystal microbalance.

3. The method of claim 1, wherein the sensing platform is a nanostructure.

4. The method of claim 3, wherein the nanostructure is selected from the group consisting of a microcantilever, a nanotube, a carbon nanotube, a nanoparticle, a nanoball, a nanocantilever and combinations thereof.

5. The method of claim 1, wherein the corrodible metal is selected from the group consisting of copper, silver, cobalt, permalloy, aluminum, gold, zinc, platinum, molybdenum, titanium, tungsten, nickel, alloys of these metals, and combinations thereof.

6. The method of claim 1, wherein the sensor array comprises at least 6 sensing platforms.

7. The method of claim 1, wherein the sensor array comprises at least 3 sensing platforms.

8. The method of claim 1, wherein the sensor array comprises at least 4 sensing platforms.

9. The method of claim 1, wherein the sensor array comprises at least 5 sensing platforms.

10. The method of claim 1, wherein the sensor array comprises from 3 to 12 sensing platforms.

11. The method of claim 1, wherein the sensor array comprises from 4 to 9 sensing platforms.

12. The method of claim 1, wherein the sensor array comprises from 5 to 8 sensing platforms.

13. The method of claim 1, wherein at least one of the corrodible metals comprises gold, and wherein a detected reaction of the gold corrodible metal indicates the presence of adverse temperature or humidity conditions in the environment.

14. The method of claim 1, wherein the contaminant comprises a corrosive gas, adverse temperature conditions, adverse humidity conditions, or combinations thereof.
